(19) United States
(12) Patent Application Publication
(10) Pub. No.: US 2026/0266031 A1
(43) Pub. Date: Sep. 10, 2026

(54) MODEL GENERATION DEVICE, DETERMINATION DEVICE, AND DETERMINATION METHOD

(71) Applicant: KOMATSU LTD., Tokyo (JP)

(72) Inventors: Masaki ISHIDA, Tokyo (JP); Shunsuke YANAKA, Tokyo (JP); Yuya MURATA, Tokyo (JP)

(73) Assignee: KOMATSU LTD., Tokyo (JP)

(21) Appl. No.: 19/491,384

(22) PCT Filed: Jul. 5, 2024
(86) PCT No.: PCT/JP2024/024353

§ 371 Date: Dec. 8, 2025

(30) Foreign Application Priority Data
Jul. 6, 2023 (JP) 2023-111640

(51) Int. Cl. E02F 9/26; G06Q 10/20

(52) U.S. Cl. CPC E02F 9/267; G06Q 10/20

(57) ABSTRACT

A model generation device executes an inspection information acquisition step, an error acquisition step, and a generation step. The inspection information acquisition step includes acquiring, for an inspection of a work machine, a time at which the inspection has been executed and presence or absence of a failure found from a result of the inspection. The error acquisition step includes acquiring a combination of error codes output before a time at which the inspection has been executed from a control device of the work machine. The control device of the work machine outputs error codes indicating types of error in a case where a state of the work machine is not a desired state. The generation step includes generating a prediction model for predicting the presence or absence of the failure from the combination of the error codes on the basis of the presence or absence of the failure and the combination of the error codes output before a time at which the inspection has been executed.

### TECHNICAL FIELD

The present disclosure relates to a model generation device, a determination device, and a determination method.

Priority is claimed on Japanese Patent Application No. 2023-111640, filed on Jul. 6, 2023, the content of which is incorporated herein by reference.

### BACKGROUND ART

A control device mounted on a work machine monitors the state of the work machine through sensors and the like, and notifies of an error in a case where the state of the work machine is not a desired state. The error notification is accompanied by an error code indicating the details of the error, and a maintenance person reads the error code to examine whether the inspection of the work machine is necessary. Patent Document 1 discloses a technique of determining the degree of abnormality in a work machine from an error code.

### PRIOR ART LITERATURE

### Patent Literature

Patent Document 1: JP 2002-180502 A

### SUMMARY OF INVENTION

### Technical Problem

An error is output when the measurement value of a sensor exceeds a predetermined range or when control of communication or the like fails. Therefore, the occurrence of an error does not necessarily indicate a failure of a work machine. Therefore, it is difficult for a maintenance person to examine whether the inspection of the work machine is necessary from an error code. In addition, the accuracy of examination may vary depending on the experience of the maintenance person.

An object of the present disclosure is to provide a model generation device, a determination device, and a determination method for accurately determining whether the inspection of a work machine is necessary from an error code on the basis of the past inspection results and the occurrence status of error codes in the work machine.

### Means for Solving Problem

According to an aspect of the present invention, there is provided a model generation device including a processor, wherein the processor executes an inspection information acquisition step of acquiring, for an inspection of a work machine, a time at which the inspection has been executed and presence or absence of a failure found from a result of the inspection, an error acquisition step of acquiring a combination of error codes output before a time at which the inspection has been executed from a control device of the work machine that outputs error codes indicating types of error in a case where a state of the work machine is not a desired state, and a generation step of generating a prediction model for predicting the presence or absence of the failure from the combination of the error codes on the basis of the presence or absence of the failure and the combination of the error codes output before a time at which the inspection has been executed.

### Effects of Invention

According to the above aspect, by using a prediction model, it is possible to accurately determine whether the inspection of a work machine is necessary from an error code on the basis of the past inspection results of the work machine.

### BRIEF DESCRIPTION OF DRAWINGS

FIG. 1 is a schematic diagram illustrating a configuration of a trigger notification system according to a first embodiment.

FIG. 2 is a schematic block diagram illustrating the configuration of a control device according to the first embodiment.

FIG. 3 is a schematic block diagram illustrating a configuration of a management server according to the first embodiment.

FIG. 4 is a flowchart illustrating a model generation process performed by the management server according to the first embodiment.

FIG. 5 is a diagram illustrating an example of a prediction model according to the first embodiment.

FIG. 6 is a flowchart illustrating a trigger generation process performed by the management server according to the first embodiment.

FIG. 7 is a flowchart illustrating a model generation process according to a management server according to a second embodiment.

FIG. 8 is a diagram illustrating an example of a prediction model according to the second embodiment.

FIG. 9 is a flowchart illustrating a trigger generation process according to the management server according to the first embodiment.

### DESCRIPTION OF EMBODIMENTS

### First Embodiment

### <<Configuration of Trigger Notification System 1>>

Hereinafter, embodiments will be described in detail with reference to the drawings.

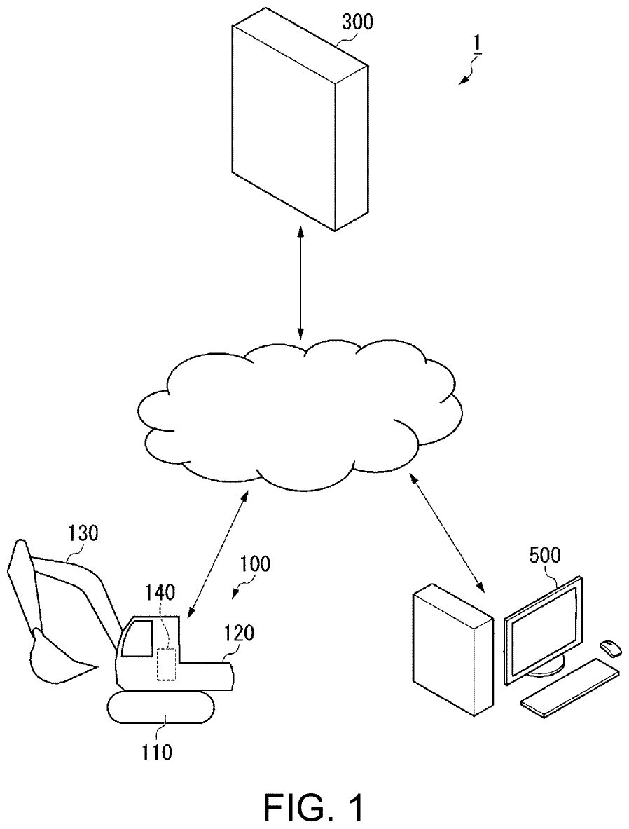

FIG. 1 is a schematic diagram illustrating a configuration of a trigger notification system 1 according to a first embodiment. The trigger notification system 1 determines whether the inspection of a work machine 100 is necessary, and presents the work machine 100 determined to require inspection to a maintenance person. That is, the trigger notification system 1 notifies the maintenance person of a trigger for the inspection of the work machine 100. The maintenance person can recognize an appropriate timing for the inspection of the work machine 100 based on the trigger notified from the trigger notification system 1.

The trigger notification system 1 includes the work machine 100, a management server 300, and a maintenance person's terminal 500. The work machine 100, the management server 300, and the maintenance person's terminal 500 are communicably connected to each other through a network.

In a case where the work machine 100 is, for example, a hydraulic excavator, it operates at a construction site and performs work such as excavating earth and sand. The work machine 100 shown in FIG. 1 is a hydraulic excavator, but in other embodiments, it may be any other work machine. Examples of the work machine 100 include a bulldozer, a dump truck, a forklift, a wheel loader, a motor grader, and the like. The work machine 100 monitors the state of a host vehicle, and transmits error data to the management server 300 in a case where the state is not a desired state.

The management server 300 determines the work machine 100 to be inspected on the basis of the error data of the work machine 100.

The management server 300 stores the error data of the work machine 100 and a history of inspection information of the work machine 100. The management server 300 generates a prediction model that predicts the presence or absence of a failure of the work machine 100 on the basis of the error data and the history of inspection information. The management server 300 determines the work machine 100 to be inspected on the basis of the prediction model, and transmits trigger information indicating the work machine 100 to be inspected to the maintenance person's terminal 500. That is, the management server 300 is an example of a model generation device, and the management server 300 is an example of a determination device.

The maintenance person's terminal 500 displays or prints the trigger information generated by the management server 300. In addition, the maintenance person's terminal 500 accepts an input of inspection result data indicating the inspection result of the work machine 100 by the maintenance person, and transmits the data to the management server 300. The inspection result data includes the date and time of the inspection, the presence or absence of a failure, and the details of the inspection and the failure.

### <<Configuration of Work Machine 100>>

The work machine 100 includes a traveling body 110, a revolving body 120, a work implement 130, and a control device 140.

The traveling body 110 supports the work machine 100 so that the work machine 100 can travel. The traveling body 110 is, for example, a pair of left and right endless tracks.

The revolving body 120 is supported by the traveling body 110 so as to be rotatable about a revolution center.

The work implement 130 is supported at a front portion of the revolving body 120 so as to be drivable in an up-down direction. The work implement 130 is driven by hydraulic pressure. Here, a portion of the revolving body 120 where the work implement 130 is attached is referred to as a front portion. Further, in the revolving body 120, with reference to the front portion, a portion on a side opposite thereto is referred to as a rear portion, a portion on the left side is referred to as a left portion, and a portion on the right side is referred to as a right portion.

The control device 140 controls the traveling body 110, the revolving body 120, and the work implement 130 on the basis of the operation of an operator. The control device 140 is provided, for example, inside the cab. The control device 140 is an example of a fall risk presentation device.

The work machine 100 includes a plurality of sensors 141 for detecting the work state of the work machine 100. Specifically, the work machine 100 includes a service meter, an engine speed sensor, an exhaust temperature sensor, an oil temperature sensor, a hydraulic pressure sensor, a tilt sensor, and the like.

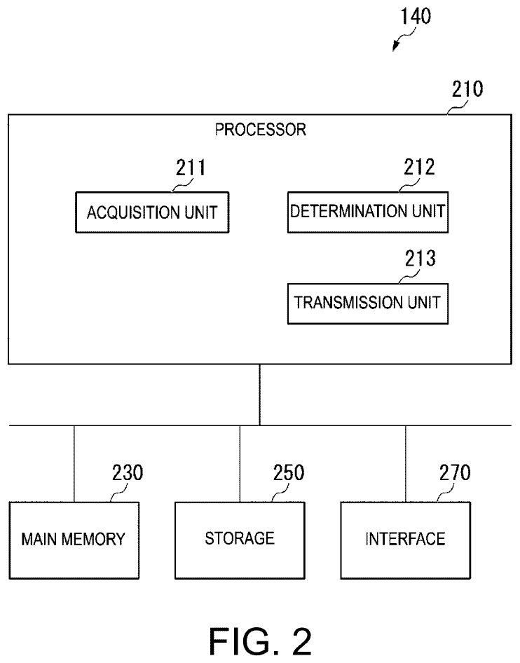

FIG. 2 is a schematic block diagram illustrating a configuration of the control device 140 according to the first embodiment.

The control device 140 is a computer including a processor 210, a main memory 230, a storage 250, and an interface 270.

The storage 250 is a non-transitory, tangible storage medium. Examples of the storage 250 include a magnetic disk, an optical disc, a magneto-optical disk, and a semiconductor memory. The storage 250 may be an internal medium directly connected to the bus of the control device 140, or an external medium connected to the control device 140 through the interface 270 or a communication line. The storage 250 stores a program for controlling the work machine 100.

The program may be used to realize some of functions to be performed by the control device 140. For example, the program may be used to perform a function in combination with other programs already stored in the storage 250 or in combination with other programs implemented in other devices. Meanwhile, in other embodiments, the control device 140 may include a custom large scale integrated circuit (LSI) such as a programmable logic device (PLD) in addition to or instead of the above configuration. Examples of the PLD include a programmable array logic (PAL), a generic array logic (GAL), a complex programmable logic device (CPLD), and a field programmable gate array (FPGA). In this case, some or all of the functions realized by the processor may be realized by the integrated circuit.

The processor 210 executes a program to function as an acquisition unit 211, a determination unit 212, and a transmission unit 213.

The acquisition unit 211 acquires measurement values from each of the plurality of sensors 141.

The determination unit 212 determines the presence or absence of an error on the basis of the measurement value acquired by the acquisition unit 211. The determination unit 212 determines that there is an error in a case where the measurement value exceeds a predetermined range. In addition, the determination unit 212 determines that there is an error in a case where the acquisition unit 211 cannot acquire the measurement value from the sensor 141. The determination unit 212 specifies an error code indicating the details of the error.

The transmission unit 213 transmits error data indicating the error detected by the determination unit 212 to the management server 300. The error data includes identification information of the work machine 100, an error occurrence time, and an error code. The transmission unit 213 transmits the error data to the management server 300 at a predetermined transmission timing. The transmission unit 213 may transmit the error data through batch processing, or may transmit it to the management server 300 in real time. In a case where the error data is transmitted through batch processing, the acquisition unit 211 records the error data in the storage 250, and the transmission unit 213 transmits it to the management server 300. Meanwhile, in order to reduce the amount of communication, the transmission unit 213 may compress and transmit the history data as necessary.

In addition, in order to reduce the amount of communication, the transmission unit 213 may not transmit error data other than the first error even if an error related to the same error code occurs multiple times within a predetermined notification suppression time. Specifically, in a case where an error of the same error code occurs within a predetermined notification suppression time (for example, 20 hours) from the detection time of an error at which the previous error data has been transmitted, the transmission unit 213 does not notify of the error. For example, a case where an error related to a tilt occurs at 0 o'clock, 10 o'clock, and 22 o'clock will be described. The error detected at 0 o'clock is a first error. Therefore, the transmission unit 213 transmits error data related to the error detected at 0 o'clock to the management server 300. The error detected at 10 o'clock is an error related to the same error code as the error detected at 0 o'clock, and 20 hours which is the notification suppression time has not elapsed since detection. Therefore, the transmission unit 213 does not transmit the error data related to the error detected at 10 o'clock. The error detected at 22 o'clock is an error related to the same error code as the error detected at 0 o'clock, but 20 hours which is the notification suppression time has elapsed since detection. Therefore, the transmission unit 213 transmits error data related to the error detected at 22 o'clock to the management server 300.

### <<Configuration of Management Server 300>>

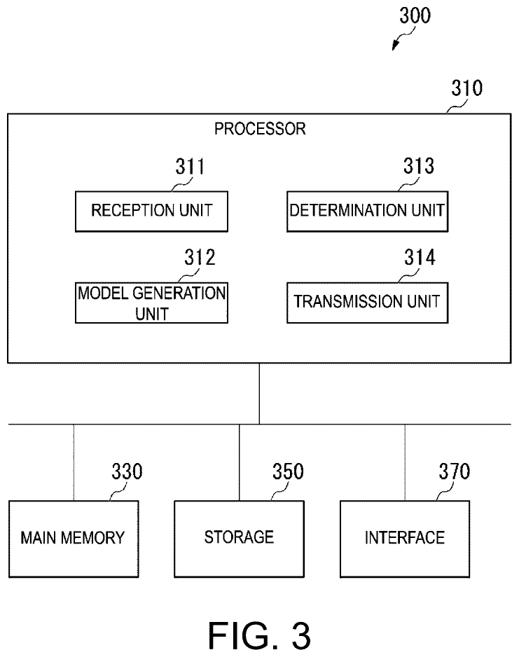

FIG. 3 is a schematic block diagram illustrating a configuration of the management server 300 according to the first embodiment.

The management server 300 is a computer including a processor 310, a main memory 330, a storage 350, and an interface 370.

The storage 350 is a non-transitory tangible storage medium. Examples of the storage 350 include a magnetic disk, an optical disc, a magneto-optical disk, and a semiconductor memory. The storage 350 may be an internal medium directly connected to the bus of the management server 300, or may be an external medium connected to the management server 300 through the interface 370 or a communication line. The storage 350 stores a program for generating an incident report.

The program may be used to realize some of functions to be performed by the management server 300. For example, the program may be used to perform a function in combination with other programs already stored in the storage 350 or in combination with other programs implemented in other devices. Meanwhile, in other embodiments, the management server 300 may include a custom LSI in addition to or instead of the above configuration. In this case, some or all of the functions realized by the processor 310 may be realized by the integrated circuit. In addition, in other embodiments, the management server 300 may be realized by a computer which is virtualized on one or a plurality of computers.

The processor 310 executes a program to function as a reception unit 311, a model generation unit 312, a determination unit 313, and a transmission unit 314.

The reception unit 311 receives error data from the work machine 100. The reception unit 311 records the received error data in the storage 350.

The reception unit 311 receives inspection result data from the maintenance person's terminal 500. The reception unit 311 records the received inspection result data in the storage 350. The maintenance person performs a direct inspection of the work machine 100 to determine the presence or absence of a failure, and generates inspection result data by inputting the determination result into the maintenance person's terminal 500. Meanwhile, the direct inspection is not necessarily performed when an error codes occurs, but rather in response to some trigger, such as when the maintenance person receives a request from a site supervisor. The reception unit 311 receives error data that occurred immediately before a timing at which the maintenance person performed a direct inspection, and inspection result data indicating the result of the direct inspection.

The model generation unit 312 generates a prediction model for predicting the presence or absence of a failure of the work machine 100 from a combination of error codes output by the work machine 100, on the basis of the past error data and inspection result data recorded in the storage 350. Specifically, the model generation unit 312 generates a prediction model which is a table showing the failure rate and P value for each combination pattern of the error codes by cross-tabulating the error codes and the presence or absence of a failure. The P value is the probability that a certain error code combination pattern will become a failure rate in a probability density distribution indicating the failure rate when the failure is assumed to occur regardless of the error code combination. The model generation unit 312 records the created prediction model in the storage 350.

The determination unit 313 determines whether the inspection of the work machine 100 is necessary on the basis of the error data received from the work machine 100 within the most recent target period (for example, the most recent 30 hours) and the prediction model recorded in the storage 350. The target period is a period of a predetermined time in the past starting from the present, and is at least a period longer than the notification suppression time for the same error by the work machine 100. For example, in a case where error data related to error codes A, B, and C is received during the target period, the determination unit 313 reads out the failure rate and P value associated with the combination of the error codes A, B, and C. The failure rate is a value in which, for a combination of error codes, the number of inspections having occurred when the combination is represented in the past is a denominator and the number of failures having been found is a numerator. The determination unit 313 determines that an inspection is necessary in a case where the readout failure rate is equal to or greater than a predetermined threshold (for example, 70%) and the readout P value satisfies a predetermined significance level (for example, 5%). On the other hand, in a case where the readout failure rate is less than a predetermined threshold, or a case where the readout P value does not satisfy a predetermined significance level, the determination unit 313 determines that an inspection is unnecessary. This is because the P value not satisfying the significance level indicates that the combination of the error codes is sufficiently likely not to be related to the failure. As an example of a combination of error codes A, B, and C that may occur in parallel, the error code A is an abnormal oil temperature, the error code B is an abnormal fuel injector, and the error code C is an abnormal coolant sound.

The transmission unit 314 transmits a list indicating the work machines 100 that require inspection among a plurality of work machines 100, as trigger data, to the maintenance person's terminal 500 on the basis of the determination result of the determination unit 313. The list includes the failure rate and P value read out by the determination unit 313 in addition to whether the inspection of is necessary. The maintenance person can recognize the work machines 100 that require inspection based on the trigger data displayed on the maintenance person's terminal 500.

### <<Process of Management Server 300>>

The reception unit 311 of the management server 300 records error data in the storage 350 each time it receives the error data from the work machine 100, and records inspection result data in the storage 350 each time it receives the inspection result data from the maintenance person's terminal 500.

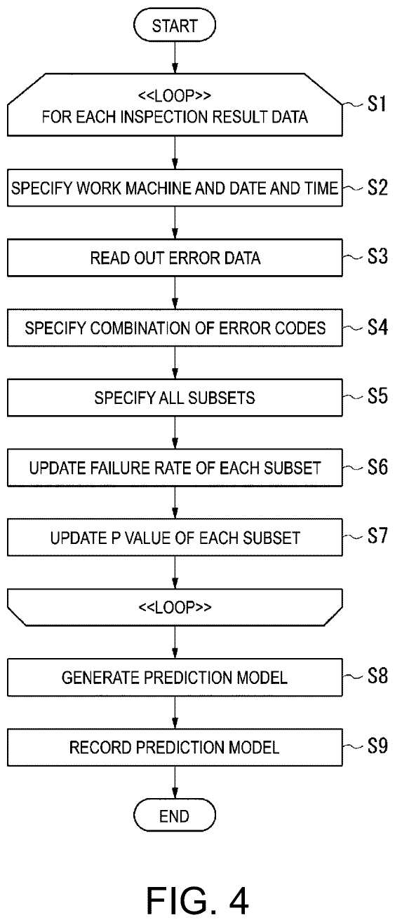

FIG. 4 is a flowchart illustrating a model generation process performed by the management server 300 according to the first embodiment. When an instruction to generate a prediction model is accepted from an administrator, the management server 300 executes the process shown in FIG. 4.

First, the model generation unit 312 of the management server 300 selects the inspection result data recorded in the storage 350 one by one (step S1), and executes the processes from step S2 to step S7 for each piece of inspection result data. The model generation unit 312 specifies the work machine 100 to be inspected and the date and time of the inspection from the selected inspection result data (step S2). The model generation unit 312 reads out, from the storage 350, error data related to the specified work machine 100, the error data having occurred in a target period ending at the specified date and time (for example, a period from 30 hours before the specified date and time to the specified date and time) (step S3).

The model generation unit 312 specifies a combination of error codes that have occurred in the target period from the readout error data (step S4). The model generation unit 312 specifies all error code patterns that can be configured with the error codes related to the specified combination (step S5). For example, in a case where the combination of error codes {A, B, C} is specified in step S4, the model generation unit 312 specifies the error code patterns {A}, {B}, {C}, {A, B}, {B, C}, {A, C}, and {A, B, C} in step S5. The model generation unit 312 updates the failure rate of each specified error code pattern on the basis of the presence or absence of a failure indicated by the inspection result data selected in step S1 (step S6). That is, the model generation unit 312 reads an error occurrence status for each inspection indicated by the inspection result data selected in step S1, and re-calculates and updates the failure rate for each error code pattern corresponding to the error occurrence status. The failure rate is defined as a rate in which the denominator is the number of inspections performed during a period when the combination of error codes related to an error code pattern is represented and the numerator is the number of failures that have been found. Specifically, for the failure rate of each error code pattern, the model generation unit 312 adds 1 to the denominator and numerator in a case where the inspection result data indicates there is a failure, and adds 1 to the denominator in a case where the inspection result data indicates there is no failure. In addition, the model generation unit 312 updates the P value for each error code pattern specified in step S5 (step S7). Meanwhile, the failure rate and P value are calculated by forming a population for each model of the work machine 100. The failure rate and P value may be calculated by forming a population not only for each model but also for each classification such as vehicle class or region.

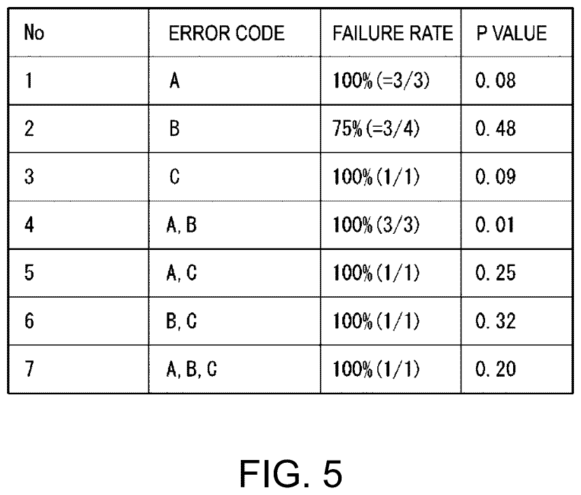

The model generation unit 312 generates a prediction model which is a table showing the failure rate and P value for each error code pattern on the basis of the calculation results from step S1 to step S7 (step S8). The model generation unit 312 records the generated prediction model in the storage 350 (step S9). FIG. 5 is a diagram illustrating an example of a prediction model according to the first embodiment. FIG. 5 shows an example of a case where there are three types of error codes A, B, and C. Meanwhile, the prediction model may be obtained by extracting only combinations of error codes in which the failure rate is equal to or greater than a predetermined threshold (for example, 70%) and the readout P value satisfies a predetermined significance level (for example, 5%) among all combinations of error codes.

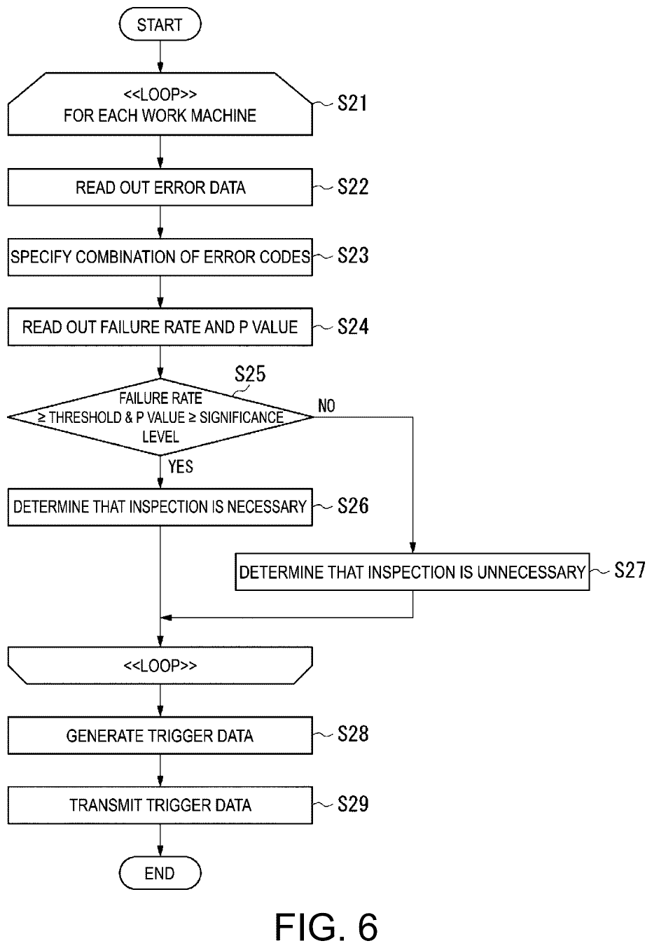

FIG. 6 is a flowchart illustrating a trigger generation process performed by the management server 300 according to the first embodiment. The management server 300 executes the process shown in FIG. 6 at each predetermined period.

First, the determination unit 313 of the management server 300 selects a plurality of work machines 100 one by one (step S21), and executes the processes from step S22 to step S27 for each work machine 100. The determination unit 313 reads out error data related to the selected work machine 100, the error data having occurred in the target period ending at the current time (for example, a period from 30 hours before the current time to the current time), from the storage 350 (step S22).

The determination unit 313 specifies the combination of error codes that have occurred in the target period from the readout error data (step S23). The determination unit 313 reads out the failure rate and P value associated with the combination of error codes specified in step S23 (step S24). The determination unit 313 determines whether the readout failure rate is equal to or greater than a predetermined threshold (for example, 70%) and whether the readout P value is equal to or greater than a predetermined significance level (for example, 5%) (step S25). In a case where the failure rate is equal to or greater than the threshold and the P value is equal to or greater than the significance level (step S25: YES), the determination unit 313 determines that the inspection is necessary for the work machine 100 selected in step S21 (step S26). On the other hand, in a case where the failure rate is less than the threshold or the P value is less than the significance level (step S25: NO), the determination unit 313 determines that the inspection is unnecessary for the work machine 100 selected in step S21 (step S27).

The transmission unit 314 generates a list indicating the work machines 100 that require inspection among the plurality of work machines 100, as trigger data, on the basis of the determination results from step S21 to step S27 (step S28). The trigger data includes the failure rate and P value read out by the determination unit 313 in addition to whether the inspection of is necessary. The transmission unit 314 transmits the trigger data to the maintenance person's terminal 500 (step S29). The transmission unit 314 transmits the trigger data to, for example, the terminal of the maintenance person in charge of the maintenance service of the work machine 100 that requires inspection. Meanwhile, in other embodiments, the transmission unit 314 may transmit the trigger data to an owner of the work machine 100, or may transmit the trigger data to a monitor provided on the work machine 100 for notifying an operator.

### <<Actions and Effects>>

In this way, the management server 300 according to the first embodiment executes an inspection information acquisition step of acquiring, for an inspection of a work machine 100, a time at which the inspection has been executed and presence or absence of a failure found from a result of the inspection, an error acquisition step of acquiring a combination of error codes output from a control device 140 of the work machine 100, and a generation step of generating a prediction model for predicting the presence or absence of the failure from the combination of the error codes on the basis of the time at which the inspection has been executed, the presence or absence of the failure, and the combination of the error codes.

This enables the management server 300 to generate a prediction model that predicts the presence or absence of a failure on the basis of the history of the past error data and the actual inspection results. That is, the management server 300 can generate a prediction model for accurately determining whether the inspection of the work machine is necessary from the error codes on the basis of the past inspection results of the work machine 100.

In addition, the management server 300 according to the first embodiment executes an error acquisition step of acquiring a combination of error codes output from the control device 140 of the work machine 100, and an output step of outputting information on whether the inspection of the work machine 100 is necessary on the basis of the prediction model and the combination of error codes. This enables the management server 300 to accurately determine whether the inspection of the work machine 100 is necessary from the error codes on the basis of the past inspection results of the work machine 100.

### Second Embodiment

The management server 300 according to the first embodiment generates a prediction model by cross tabulation based on the inspection result data. In contrast, a management server 300 according to a second embodiment generates a prediction model by cross tabulation based on the error codes of the work machine 100.

The configuration of a trigger notification system 1 according to the second embodiment is the same as that of the first embodiment. On the other hand, the second embodiment differs from the first embodiment in a method of generating a prediction model by the management server 300.

<<Process of Management Server 300>>The reception unit 311 of the management server 300 records error data in the storage 350 each time it receives the error data from the work machine 100, and records inspection result data in the storage 350 each time it receives the inspection result data from the maintenance person's terminal 500.

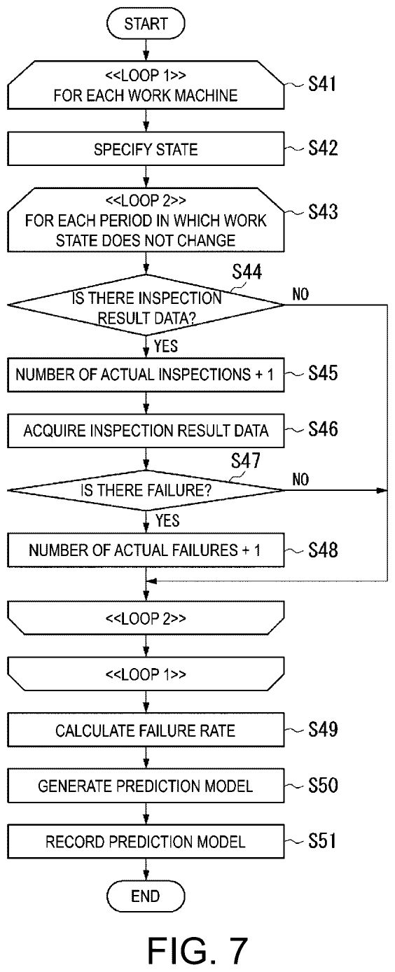

FIG. 7 is a flowchart illustrating a model generation process performed by the management server 300 according to the second embodiment. When an instruction to generate a prediction model is accepted from an administrator, the management server 300 executes the process shown in FIG. 7.

First, the model generation unit 312 of the management server 300 selects the work machine 100 one by one (step S41), and executes the processes from step S42 to step S48 for each work machine 100. The model generation unit 312 specifies the state of the work machine 100 represented by the combination of error codes detected in the target period ending at a corresponding time for a plurality of times obtained by dividing the period from the time related to the oldest error data recorded in the storage 350 to the current time into predetermined times (step S42). The state of the work machine 100 is represented as a vector indicating a pattern of the combination of error codes. For example, in a case where there are five types of error codes A, B, C, D, and E, and error data related to error codes A, B, and E in the target period, the state of the work machine 100 is represented as {1, 1, 0, 0, 1}.

The model generation unit 312 selects the periods in which the work state specified in step S42 does not change one by one (step S43), and executes the processes from step S44 to step S48 below for each period. For example, in a case where the state of the work machine 100 is {1, 0, 0, 0, 0} at time t1, time t2, and time t3, the state of the work machine 100 is {1, 1, 0, 0, 0} at time t4 and time t5, and the state of the work machine 100 is {1, 1, 0, 0, 1} at time t6, time t7, and time t8, the model generation unit 312 selects the period from time t1 to time t3, the period from time t4 to time t5, and the period from time t6 to time t8.

The model generation unit 312 determines whether there is inspection result data related to the work machine 100 selected in step S41 which has been generated during the period selected in step S43 (step S44). In a case where there is inspection result data generated during the period selected in step S43 (step S44: YES), the model generation unit 312 adds 1 to the number of actual inspections for the state related to the period (step S45). The model generation unit 312 acquires all pieces of inspection result data related to the work machine 100 selected in step S41 which has been generated during the period selected in step S43 (step S46). The model generation unit 312 determines whether one or more failures are detected in the acquired inspection result data (step S47). In a case where there are one or more pieces of inspection result data in which a failure is detected (step S47: YES), the model generation unit 312 adds 1 to the number of actual failures for the state related to the period (step S48).

Meanwhile, in a case where is no inspection result data related to the work machine 100 selected in step S41 which has been generated during the period selected in step S43 (step S44: NO), the model generation unit 312 does not add the number of actual inspections related to the state of the work machine 100 related to the period.

In addition, in a case where no failures have been detected in all pieces of inspection result data related to the work machine 100 selected in step S41 which has been generated during the period selected in step S43 (step S47: NO), the model generation unit 312 does not add the number of actual failures related to the state of the work machine 100 related to the period.

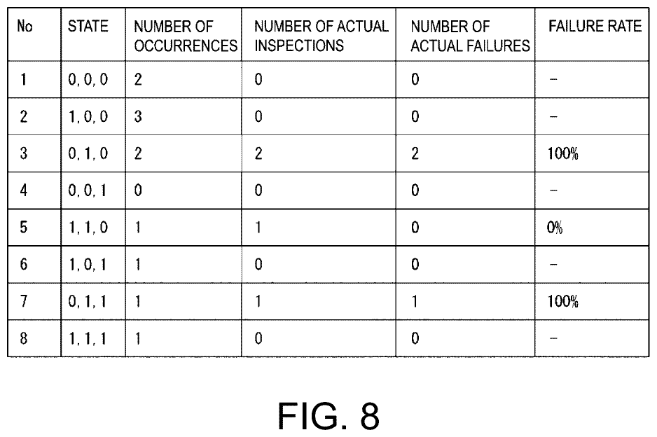

The model generation unit 312 calculates the failure rate by dividing the number of actual failures by the number of actual inspections for each combination pattern of error codes (step S49). The model generation unit 312 then generates a prediction model in which at least the failure rate related to the pattern and the number of actual inspections are associated with the combination pattern of error codes (step S50). The model generation unit 312 records the generated prediction model in the storage 350 (step S51). FIG. 8 is a diagram illustrating an example of a prediction model according to the second embodiment. FIG. 8 shows an example of a case where there are three types of error codes.

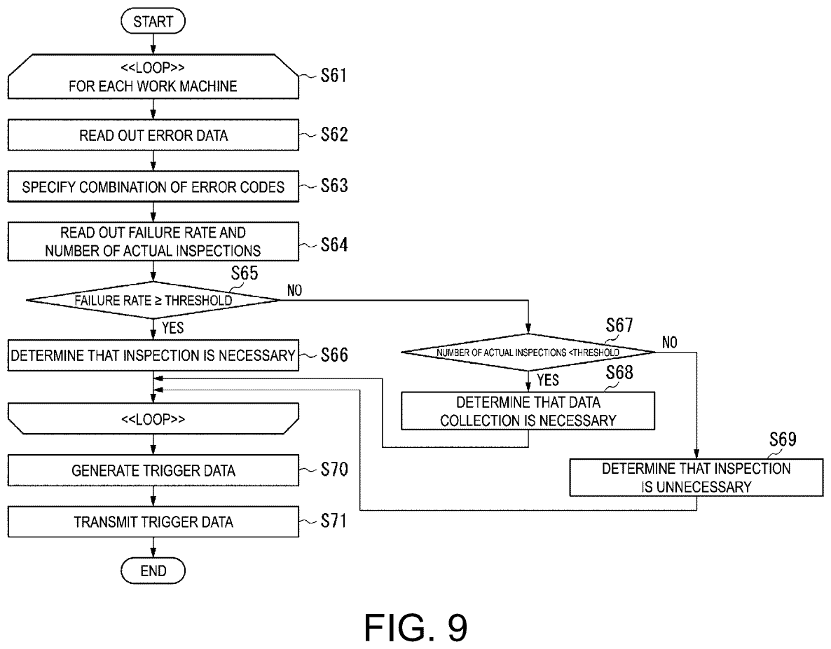

FIG. 9 is a flowchart illustrating a trigger generation process performed by the management server 300 according to the first embodiment. The management server 300 executes the process shown in FIG. 9 at each predetermined period.

First, the determination unit 313 of the management server 300 selects a plurality of work machines 100 one by one (step S61), and executes the processes from step S62 to step S69 for each work machine 100. The determination unit 313 reads out error data related to the selected work machine 100, the error data having occurred in the target period ending at the current time (for example, a period from 30 hours before the current time to the current time), from the storage 350 (step S62).

The determination unit 313 specifies the combination of error codes that have occurred in the target period from the readout error data (step S63). The determination unit 313 reads out the failure rate and the number of actual inspections associated with the combination of error codes specified in step S63 (step S64). The determination unit 313 determines whether the readout failure rate is equal to or greater than a predetermined threshold (for example, 70%) (step S65). In a case where the failure rate is equal to or greater than the threshold (step S65: YES), the determination unit 313 determines that the inspection is necessary for the work machine 100 selected in step S61 (step S66).

In addition, the determination unit 313 determines whether the readout number of actual inspections is less than a predetermined threshold (for example, five) (step S67). In a case where the number of actual inspections is less than the threshold (step S67: YES), the determination unit 313 determines that it is preferable to perform an inspection on the work machine 100 selected in step S61 for data collection (step S68).

On the other hand, in a case where the failure rate is less than the threshold and the number of actual inspections is equal to or greater than the threshold (step S67: NO), the determination unit 313 determines that the inspection is unnecessary for the work machine 100 selected in step S21 (step S69).

The transmission unit 314 generates a list indicating the work machines 100 that require inspection among the plurality of work machines 100, as trigger data, on the basis of the determination result from step S61 to step S69 (step S70). The trigger data includes the failure rate and the number of actual inspections read out by the determination unit 313 in addition to whether the inspection of is necessary. The transmission unit 314 transmits the trigger data to the maintenance person's terminal 500 (step S71).

### <<Actions and Effects>>

In this way, the management server 300 according to the second embodiment determines, for each period in which the combination of error codes does not change, whether at least one failure has been found in the period, and generates a prediction model by statistical processing based on the number of periods in which at least one failure has been found. That is, the management server 300 counts the inspection result as 1 even if multiple inspections are performed during a period in which the combination of error codes does not change. This enables the management server 300 to prevent bias from occurring in the weight of the inspection response even if multiple inspections are performed in one failure response. In addition, the management server 300 specifies the combination of error codes as the state of the work machine 100, and therefore outputs one failure rate regardless of the number of error codes generated by the work machine 100.

In addition, the management server 300 according to the second embodiment executes a specification step of specifying a combination of error codes having a low number of records in the inspection. This makes it possible to prompt the maintenance person to collect data for the state of the work machine 100 with low accuracy due to a small amount of data in the prediction model.

### Other Embodiments

Although several embodiments have been described in detail above with reference to the drawings, the specific configurations are not limited to those described above, and various design modifications and the like are possible. That is, in other embodiments, the order of the processing described above may be changed as appropriate. Further, some processing may be executed in parallel.

The management server 300 according to the above-described embodiment may be configured as a single computer, or the configuration of the management server 300 may be divided and arranged in a plurality of computers, and the plurality of computers may cooperate with each other to function as the management server 300. For example, in other embodiments, the function of the management server 300 as a model generation device that generates a prediction model and the function as a determination device that determines whether an inspection is necessary on the basis of the prediction model may be implemented in separate computers.

The management server 300 according to the above-described embodiment generates a prediction model by statistical processing called cross tabulation, but there is no limitation thereto. For example, the management server 300 according to another embodiment may generate a prediction model by statistical processing using a machine learning model such as a neural network model. For example, the management server 300 generates, for each piece of inspection result data, a combination of the state of the work machine 100 (combination of error codes) at the inspection time and the presence or absence of a failure at a learning data set. The management server 300 then trains the parameters of the estimation model which is a machine learning model, in the learning data set, so that the state of the work machine 100 is used as an input and the failure rate is used as an output. Such statistical processing enables the management server 300 to generate a prediction model using a machine learning model.

The prediction model according to the above-described embodiment represents the relationship between the failure rate and the P value for each error code pattern as shown in FIG. 5, but there is no limitation thereto in other embodiments. For example, the prediction model according to another embodiment may further store the details of a failure in addition to the failure rate and P value in association with each other. In addition, for example, the prediction model according to another embodiment may store the failure rate and P value by failure details.

### INDUSTRIAL APPLICABILITY

According to the above aspect, by using a prediction model, it is possible to accurately determine whether the inspection of a work machine is necessary from an error code on the basis of the past inspection results of the work machine.

### REFERENCE SIGNS LIST

1 . . . Trigger notification system, 100 . . . Work machine, 110 . . . Traveling body, 120 . . . Revolving body, 130 . . . Work implement, 140 . . . Control device, 141 . . . Sensor, 210 . . . Processor, 211 . . . Acquisition unit, 212 . . . Determination unit, 213 . . . Transmission unit, 230 . . . Main memory, 250 . . . Storage, 270 . . . Interface, 300 . . . Management server, 310 . . . Processor, 311 . . . Reception unit, 312 . . . Model generation unit, 313 . . . Determination unit, 314 . . . Transmission unit, 330 . . . Main memory, 350 . . . Storage, 370 . . . Interface, 500 . . . Maintenance person's terminal

1. A model generation device comprising a processor,
wherein the processor executes:
an inspection information acquisition step of acquiring, for an inspection of a work machine, a time at which the inspection has been executed and presence or absence of a failure found from a result of the inspection,
an error acquisition step of acquiring a combination of error codes output before the time at which the inspection has been executed from a control device of the work machine that outputs error codes indicating types of error in a case where a state of the work machine is not a desired state, and
a generation step of generating a prediction model for predicting the presence or absence of the failure from the combination of the error codes on the basis of the presence or absence of the failure and the combination of the error codes output before the time at which the inspection has been executed.

2. The model generation device according to claim 1, wherein the generation step includes generating the prediction model by performing statistical processing on the presence or absence of the failure and the combination of the error codes output before the time at which the inspection has been executed for each of a plurality of inspections.

3. The model generation device according to claim 1, wherein the generation step includes generating the prediction model by performing statistical processing on a pattern of the combination of the error codes output before the time at which the inspection has been executed and the presence or absence of the failure in each of the inspections.

4. The model generation device according to claim 3, wherein the generation stepincludes determining, for each period during which the combination of the error codes does not change, whether at least one failure has been found in the period, and generating the prediction model by performing statistical processing based on the number of periods during which the at least one failure has been found.

5. The model generation device according to claim 3, wherein the processor further executes a specification step of specifying the combination of the error codes having a low number of records in the inspection.

6. A determination device comprising a processor,
wherein the processor executes:
an error acquisition step of acquiring a combination of error codes output before a current time from a control device of a work machine that outputs error codes indicating types of error in a case where a state of the work machine is not a desired state, and
an output step of outputting information on whether an inspection of the work machine is necessary on the basis of a prediction model for predicting presence or absence of a failure from the combination of the error codes, the prediction model being generated on the basis of a time at which the inspection of the work machine has been executed, the presence or absence of the failure found from a result of the inspection, and the combination of the error codes output before the time at which the inspection has been executed, and the combination of the error codes output before the current time from the control device of the work machine.

7. A determination method comprising:
an error acquisition step of acquiring a combination of error codes output before a current time from a control device of a work machine that outputs error codes indicating types of error in a case where a state of the work machine is not a desired state; and
an output step of outputting information on whether an inspection of the work machine is necessary on the basis of a prediction model for predicting presence or absence of a failure from the combination of the error codes, the prediction model being generated on the basis of a time at which the inspection of the work machine has been executed, the presence or absence of the failure found from a result of the inspection, and the combination of the error codes output before the time at which the inspection has been executed, and the combination of the error codes output before the current time from the control device of the work machine.

8. The model generation device according to claim 4, wherein the processor further executes a specification step of specifying the combination of the error codes having a low number of records in the inspection.
